(19) United States
(12) Patent Application Publication
(10) Pub. No.: US 2019/0026295 A1
(43) Pub. Date: Jan. 24, 2019

(54) SYSTEM AND METHOD FOR OBTAINING APPLICATION INSIGHTS THROUGH SEARCH

(71) Applicant: Nutanix, Inc., San Jose, CA (US)

(72) Inventors: Atreyee Maiti, San Jose, CA (US); Himanshu Shukla, San Jose, CA (US); Rahul Singh, San Jose, CA (US)

(21) Appl. No.: 15/653,762

(22) Filed: Jul. 19, 2017

(51) Int. Cl. G06F 17/30; G06F 9/455; G06F 9/48; G06F 9/50; H04L 12/931

(52) U.S. Cl. CPC G06F 17/30088; G06F 2009/45595; G06F 17/3023; G06F 9/455; G06F 9/45533; G06F 9/45558; G06F 9/48; G06F 9/4806; G06F 9/4843; G06F 9/485; G06F 9/4856; G06F 9/4881; G06F 9/50; G06F 9/5005; G06F 9/5011; G06F 9/5016; G06F 9/5022; G06F 9/5027; G06F 9/5061; G06F 9/5072; G06F 9/5077; G06F 9/5083; G06F 9/5088; H04L 49/356; G06F 2009/45562; G06F 2009/4557; G06F 2009/45575; G06F 2009/45579; G06F 2009/45583; G06F 17/30156

(57) ABSTRACT

A system and method includes receiving, by a search computing system of a virtual computing system, a search query, converting the search query into a structured query, and identifying at least one of a configured metric, a learned metric, and a correlation from the structured query. The configured metric, learned metric, and correlation are based upon a particular metric associated with a component of the virtual computing system. The configured metric is obtained by applying filters to the particular metric, the learned metric is based upon a frequency of presence of the particular metric in the search query, and the correlation is based upon a pattern formed by the search query in conjunction with a subset of prior search queries. The system and method further include displaying data related to the particular metric, such that the data is based upon the configured metric, the learned metric, and the correlation.

### BACKGROUND

The following description is provided to assist the understanding of the reader. None of the information provided or references cited is admitted to be prior art.

Virtual computing systems are widely used in a variety of applications. Virtual computing systems include one or more host machines running one or more virtual machines concurrently. The one or more virtual machines utilize the hardware resources of the underlying one or more host machines. Each virtual machine may be configured to run an instance of an operating system. Modern virtual computing systems allow several operating systems and several software applications to be safely run at the same time on the virtual machines of a single host machine, thereby increasing resource utilization and performance efficiency. However, present day virtual computing systems still have limitations due to their configuration and the way they operate.

### SUMMARY

In accordance with some aspects of the present disclosure, a method is disclosed. The method includes receiving, by a search computing system of a virtual computing system, a search query via a search interface, converting, by the search computing system, the search query into a structured query, and identifying, by the search computing system, at least one of a configured metric, a learned metric, and a correlation from the structured query. The configured metric, the learned metric, and the correlation are based upon a particular metric associated with a software application of the virtual computing system. The configured metric is obtained by applying one or more filters to the particular metric, the learned metric is based upon a frequency of presence of the particular metric in the search query, and the correlation is based upon a pattern formed by the search query in conjunction with a subset of prior search queries. The method further includes displaying, by the search computing system, data related to the particular metric on the search interface, such that the data is based upon the configured metric, the learned metric, and the correlation identified within the structured query.

In accordance with some other aspects of the present disclosure, a system is disclosed. The system includes a configuration system of a virtual computing system, the configuration system having a metric database configured to store one or more statistics counters created by the configuration system, and a processing unit. The processing unit is configured to receive a selection, via a configuration interface, of a software application, receive a selection, via the configuration interface, of a particular metric associated with the software application, and receive a selection, via the configuration interface, of one or more filter values associated with selected one of the particular metric. The processing circuit is further configured to apply the selected one of the particular metric and the one or more filter values to an instance of the one or more statistics counters, and store the instance of the one or more statistics counters within the metric database.

In accordance with yet other aspects of the present disclosure, another method is disclosed. The method includes configuring, by a configuration system of a virtual computing system, a particular metric associated with a software application of the virtual computing system to obtain a configured metric. The configuring comprises applying one or more filter values to the particular metric. The method also includes receiving, by a search computing system of the virtual computing system, a search query via a search interface, identifying, by the search computing system, keywords within the search query indicative of the configured metric, and accessing, by the search computing system, the configuration system for obtaining data corresponding to the configured metric. The method additionally includes displaying, by the search computing system, the data on the search interface.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 is a block diagram of a virtual computing system, in accordance with some embodiments of the present disclosure.

FIG. 2 is a block diagram of a search computing system, a configuration system, and a learned metric system connected together in operational association within the virtual computing system of FIG. 1, in accordance with some embodiments of the present disclosure.

FIGS. 3A-3B are block diagrams of a user injected block of the configuration system of FIG. 2, in accordance with some embodiments of the present disclosure.

FIG. 4 is a block diagram of the learned metric system of FIG. 2, in accordance with some embodiments of the present disclosure.

FIG. 5 is an example flowchart outlining operations for performing a search operation, in accordance with some embodiments of the present disclosure.

FIG. 6 is an example flowchart outlining operations for configuring a metric of a software application, in accordance with some embodiments of the present disclosure.

FIG. 7 is an example flowchart outlining operations for learning the metric, in accordance with some embodiments of the present disclosure.

FIG. 8 is an example flowchart outlining operations for learning correlations related to the metric, in accordance with some embodiments of the present disclosure.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

The present disclosure is generally directed to a search computing system and a configuration system associated with a virtual computing system. The search computing system operates in collaboration with the configuration system to provide real-time data pertaining to one or more metrics associated with a software application within the virtual computing system. The metrics provide various statistics related to the software application. For example, one of the metrics associated with the software application may be for central processing unit (CPU) utilization. The CPU utilization metric may collect statistics relating to the software application's usage of the various processing resources when the software application is running. By reviewing the statistics or data collected by the CPU utilization metric, the user may be able to identify performance problems associated with the software application. Similarly, other metrics associated with the software application may provide valuable insights about other operational and functional aspects of the software application.

Traditionally, such data is included in error logs or reports after the software application has encountered a performance or another problem. Thus, traditionally the user reviews the data after the fact. The present disclosure provides a system and method by which the data may be viewed in real-time while the software application is running. Thus, the user may be able to monitor the software application in real-time. By reviewing the data in real-time, the user may identify a problem while it is occurring or predict a problem that is about to occur. Additionally, upon identifying a currently occurring or impending problem, the user may pro-actively take action to prevent the problem or at least reduce the impact of the problem.

To monitor the software application by reviewing the data collected by the metrics in real-time, the user first configures the metrics that the user is interested in monitoring. To configure the metrics, the user uses the configuration system. Specifically, through the configuration system, the user may configure the metrics by defining various filters. The filters may include various thresholds, such as upper and lower thresholds, or any limiting attribute or parameter associated with the metric that the user is interested in monitoring. For example and with respect to the CPU utilization metric discussed above, the user may configure the CPU utilization metric by defining an upper threshold value (e.g., seventy five percent), a lower threshold value (e.g., twenty five percent), a range of threshold values (e.g., between twenty five and seventy five percent), etc. By configuring the CPU utilization metric, the CPU utilization metric may collect data from the software application that satisfies the defined filters. Therefore, for example, if the CPU utilization metric has been configured with an upper threshold value of seventy five percent, the CPU utilization metric collects data when the software application's usage of the various processing resources exceeds seventy five percent. Thus, based upon the parameters that the user is interested in monitoring, the user may configure the metrics with those parameters.

Furthermore, by configuring the metrics, the user may easily search for the data collected by those metrics. Specifically, the user may run search queries using the search computing system to obtain the data collected by the metrics as search results. To distinguish one configured metric from another configured metric, the user may create a statistics counter for each configured metric. By creating the statistics counter for the configured metrics, the user may run search queries using the created statistics counters as well.

The present disclosure also provides a learned metric system, which is configured to learn the metrics and associated parameters (e.g., thresholds) that the user commonly runs search queries for based upon a frequency of a particular search query. The learned metric system may also identify patterns within multiple search queries to create a correlation. The learned metrics or created correlations may or may not have been configured by the user. By automatically learning the metrics and creating correlations, the search computing system may access the learned metric system to return relevant search results to the user.

Thus, the present disclosure provides an efficient and convenient mechanism for a user to monitor the health of a software application in real-time, identify problems or failures occurring or impending within the software application, and timely and efficiently address the identified problems or failures to prevent adverse impact on the software application and/or other aspects of the virtual computing system.

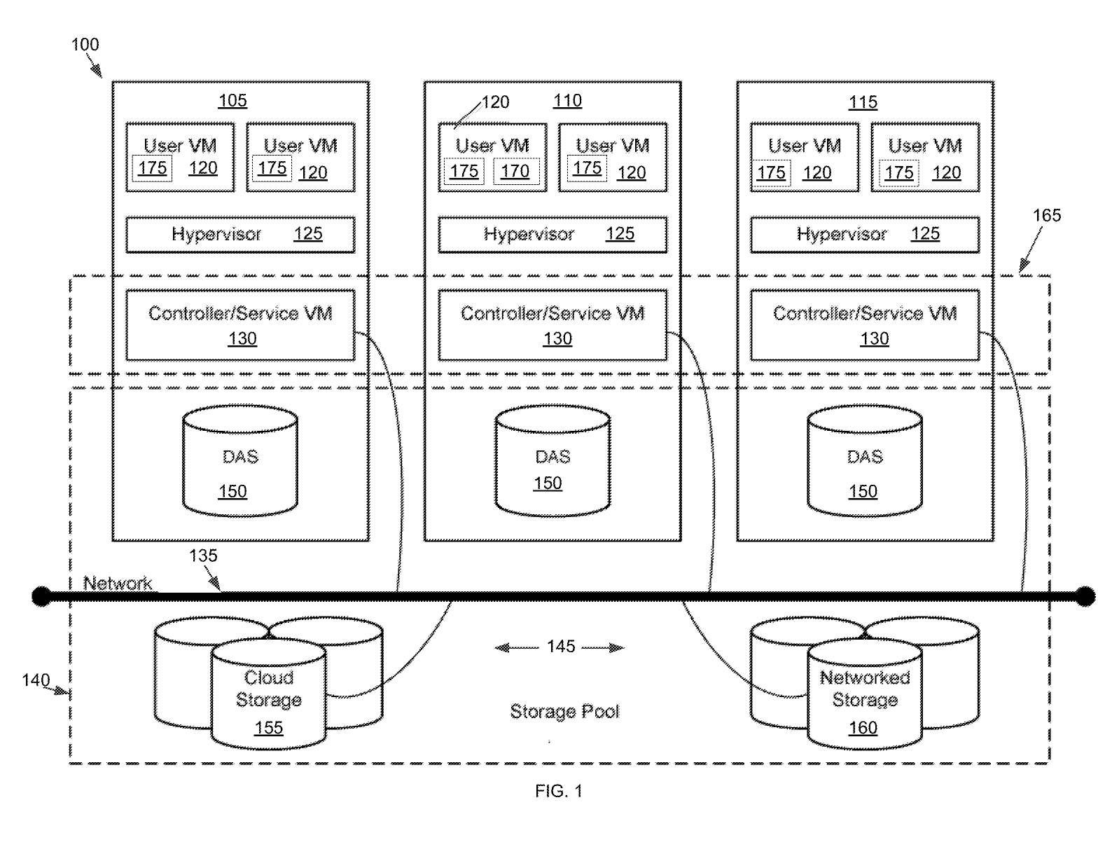

Referring now to FIG. 1, a virtual computing system 100 is shown, in accordance with some embodiments of the present disclosure. The virtual computing system 100 includes a plurality of nodes, such as a first node 105, a second node 110, and a third node 115. Each of the first node 105, the second node 110, and the third node 115 includes user virtual machines (VMs) 120 and a hypervisor 125 configured to create and run the user VMs. Each of the first node 105, the second node 110, and the third node 115 also includes a controller/service VM 130 that is configured to manage, route, and otherwise handle workflow requests to and from the user VMs 120 of a particular node. The controller/service VM 130 is connected to a network 135 to facilitate communication between the first node 105, the second node 110, and the third node 115. Although not shown, in some embodiments, the hypervisor 125 may also be connected to the network 135.

The virtual computing system 100 may also include a storage pool 140. The storage pool 140 may include network-attached storage 145 and direct-attached storage 150. The network-attached storage 145 may be accessible via the network 135 and, in some embodiments, may include cloud storage 155, as well as local storage area network 160. In contrast to the network-attached storage 145, which is accessible via the network 135, the direct-attached storage 150 may include storage components that are provided within each of the first node 105, the second node 110, and the third node 115, such that each of the first, second, and third nodes may access its respective direct-attached storage without having to access the network 135.

It is to be understood that only certain components of the virtual computing system 100 are shown in FIG. 1. Nevertheless, several other components that are commonly provided or desired in a virtual computing system are contemplated and considered within the scope of the present disclosure. Additional features of the virtual computing system 100 are described in U.S. Pat. No. 8,601,473, the entirety of which is incorporated by reference herein.

Although three of the plurality of nodes (e.g., the first node 105, the second node 110, and the third node 115) are shown in the virtual computing system 100, in other embodiments, greater or fewer than three nodes may be used. Likewise, although only two of the user VMs 120 are shown on each of the first node 105, the second node 110, and the third node 115, in other embodiments, the number of the user VMs on the first, second, and third nodes may vary to include either a single user VM or more than two user VMs. Further, the first node 105, the second node 110, and the third node 115 need not always have the same number of the user VMs 120. Additionally, more than a single instance of the hypervisor 125 and/or the controller/service VM 130 may be provided on the first node 105, the second node 110, and the third node 115.

Further, in some embodiments, each of the first node 105, the second node 110, and the third node 115 may be a hardware device, such as a server. For example, in some embodiments, one or more of the first node 105, the second node 110, and the third node 115 may be an NX-1000 server, NX-3000 server, NX-6000 server, NX-8000 server, etc. provided by Nutanix, Inc. or server computers from Dell, Inc., Lenovo Group Ltd. or Lenovo PC International, Cisco Systems, Inc., etc. In other embodiments, one or more of the first node 105, the second node 110, or the third node 115 may be another type of hardware device, such as a personal computer, an input/output or peripheral unit such as a printer, or any type of device that is suitable for use as a node within the virtual computing system 100. In some embodiments, the virtual computing system 100 may be part of a data center.

Each of the first node 105, the second node 110, and the third node 115 may also be configured to communicate and share resources with each other via the network 135. For example, in some embodiments, the first node 105, the second node 110, and the third node 115 may communicate and share resources with each other via the controller/service VM 130 and/or the hypervisor 125. Additionally and generally speaking, the first node 105, the second node 110, and the third node 115 may have attributes that are typically needed or desired in nodes of a virtual computing system (e.g., the virtual computing system 100). One or more of the first node 105, the second node 110, and the third node 115 may also be organized in a variety of network topologies, and may be termed as a “host” or “host machine.”

Also, although not shown, one or more of the first node 105, the second node 110, and the third node 115 may include one or more processing units configured to execute instructions. The instructions may be carried out by a special purpose computer, logic circuits, or hardware circuits of the first node 105, the second node 110, and the third node 115. The processing units may be implemented in hardware, firmware, software, or any combination thereof. The term “execution” is, for example, the process of running an application or the carrying out of the operation called for by an instruction. The instructions may be written using one or more programming language, scripting language, assembly language, etc. The processing units, thus, execute an instruction, meaning that they perform the operations called for by that instruction.

The processing units may be operably coupled to the storage pool 140, as well as with other elements of the respective first node 105, the second node 110, and the third node 115 to receive, send, and process information, and to control the operations of the underlying first, second, or third node. The processing units may retrieve a set of instructions from the storage pool 140, such as, from a permanent memory device like a read only memory (ROM) device and copy the instructions in an executable form to a temporary memory device that is generally some form of random access memory (RAM). The ROM and RAM may both be part of the storage pool 140, or in some embodiments, may be separately provisioned from the storage pool. Further, the processing units may include a single stand-alone processing unit, or a plurality of processing units that use the same or different processing technology.

With respect to the storage pool 140 and particularly with respect to the direct-attached storage 150, it may include a variety of types of memory devices. For example, in some embodiments, the direct-attached storage 150 may include, but is not limited to, any type of RAM, ROM, flash memory, magnetic storage devices (e.g., hard disk, floppy disk, magnetic strips, etc.), optical disks (e.g., compact disk (CD), digital versatile disk (DVD), etc.), smart cards, solid state devices, etc. Likewise, the network-attached storage 145 may include any of a variety of network accessible storage (e.g., the cloud storage 155, the local storage area network 160, etc.) that is suitable for use within the virtual computing system 100 and accessible via the network 135. The storage pool 140 including the network-attached storage 145 and the direct-attached storage 150 may together form a distributed storage system configured to be accessed by each of the first node 105, the second node 110, and the third node 115 via the network 135 and the controller/service VM 130, and/or the hypervisor 125. In some embodiments, the various storage components in the storage pool 140 may be configured as virtual disks for access by the user VMs 120.

Each of the user VMs 120 is a software-based implementation of a computing machine in the virtual computing system 100. The user VMs 120 emulate the functionality of a physical computer. Specifically, the hardware resources, such as processing unit, memory, storage, etc., of the underlying computer (e.g., the first node 105, the second node 110, and the third node 115) are virtualized or transformed by the hypervisor 125 into the underlying support for each of the plurality of user VMs 120 that may run its own operating system and applications on the underlying physical resources just like a real computer. By encapsulating an entire machine, including CPU, memory, operating system, storage devices, and network devices, the user VMs 120 are compatible with most standard operating systems (e.g. Windows, Linux, etc.), applications, and device drivers. Thus, the hypervisor 125 is a virtual machine monitor that allows a single physical server computer (e.g., the first node 105, the second node 110, third node 115) to run multiple instances of the user VMs 120, with each user VM sharing the resources of that one physical server computer, potentially across multiple environments. By running the plurality of user VMs 120 on each of the first node 105, the second node 110, and the third node 115, multiple workloads and multiple operating systems may be run on a single piece of underlying hardware computer (e.g., the first node, the second node, and the third node) to increase resource utilization and manage workflow.

The user VMs 120 are controlled and managed by the controller/service VM 130. The controller/service VM 130 of each of the first node 105, the second node 110, and the third node 115 is configured to communicate with each other via the network 135 to form a distributed system 165. The hypervisor 125 of each of the first node 105, the second node 110, and the third node 115 may be configured to run virtualization software, such as, ESXi from VMWare, AHV from Nutanix, Inc., XenServer from Citrix Systems, Inc., etc., for running the user VMs 120 and for managing the interactions between the user VMs and the underlying hardware of the first node 105, the second node 110, and the third node 115. The controller/service VM 130 and the hypervisor 125 may be configured as suitable for use within the virtual computing system 100.

The network 135 may include any of a variety of wired or wireless network channels that may be suitable for use within the virtual computing system 100. For example, in some embodiments, the network 135 may include wired connections, such as an Ethernet connection, one or more twisted pair wires, coaxial cables, fiber optic cables, etc. In other embodiments, the network 135 may include wireless connections, such as microwaves, infrared waves, radio waves, spread spectrum technologies, satellites, etc. The network 135 may also be configured to communicate with another device using cellular networks, local area networks, wide area networks, the Internet, etc. In some embodiments, the network 135 may include a combination of wired and wireless communications.

Referring still to FIG. 1, in some embodiments, one of the first node 105, the second node 110, or the third node 115 may be configured as a leader node. The leader node may be configured to monitor and handle requests from other nodes in the virtual computing system 100. If the leader node fails, another leader node may be designated. Furthermore, one or more of the first node 105, the second node 110, and the third node 115 may be combined together to form a network cluster (also referred to herein as simply “cluster.”) Generally speaking, all of the nodes (e.g., the first node 105, the second node 110, and the third node 115) in the virtual computing system 100 may be divided into one or more clusters. One or more components of the storage pool 140 may be part of the cluster as well. For example, the virtual computing system 100 as shown in FIG. 1 may be part of one cluster. Multiple clusters may exist within a given virtual computing system. The user VMs 120 that are part of a cluster may be configured to share resources with each other.

Further, as shown herein, one or more of the user VMs 120 may be configured to have a search computing system 170. In some embodiments, the search computing system 170 may be provided on one or more of the user VMs 120 of the leader node, while in other embodiments, the search computing system 170 may be provided on another node. Although the search computing system 170 has been shown as being provided on one of the user VMs 120, in some embodiments, the search computing system may be provided on multiple user VMs. In yet other embodiments, the search computing system 170 may be provided on a computing machine that is outside of the first node 105, the second node 110, and the third node 115, but connected to those nodes in operational association. In some such embodiments, the computing machine on which the search computing system 170 is provided may be either within the virtual computing system 100 or outside of the virtual computing system and operationally associated therewith. Generally speaking, the search computing system 170 may be connected to for receiving data from one or more clusters within the virtual computing system 100. Thus, either a single instance of the search computing system 170 or multiple instances of the search computing system, with each search computing system instance being connected to one or more clusters may be provided.

Furthermore, the search computing system 170 may be used to receive search queries from a user and provide results back to the user in response to the received search queries. The search results may correspond to data received back from the components of the cluster(s) that are connected to and communicating with the search computing system 170. Additional details of the search computing system are provided in U.S. application Ser. No. 15/143,060, filed on Apr. 29, 2016, the entirety of which is incorporated by reference herein.

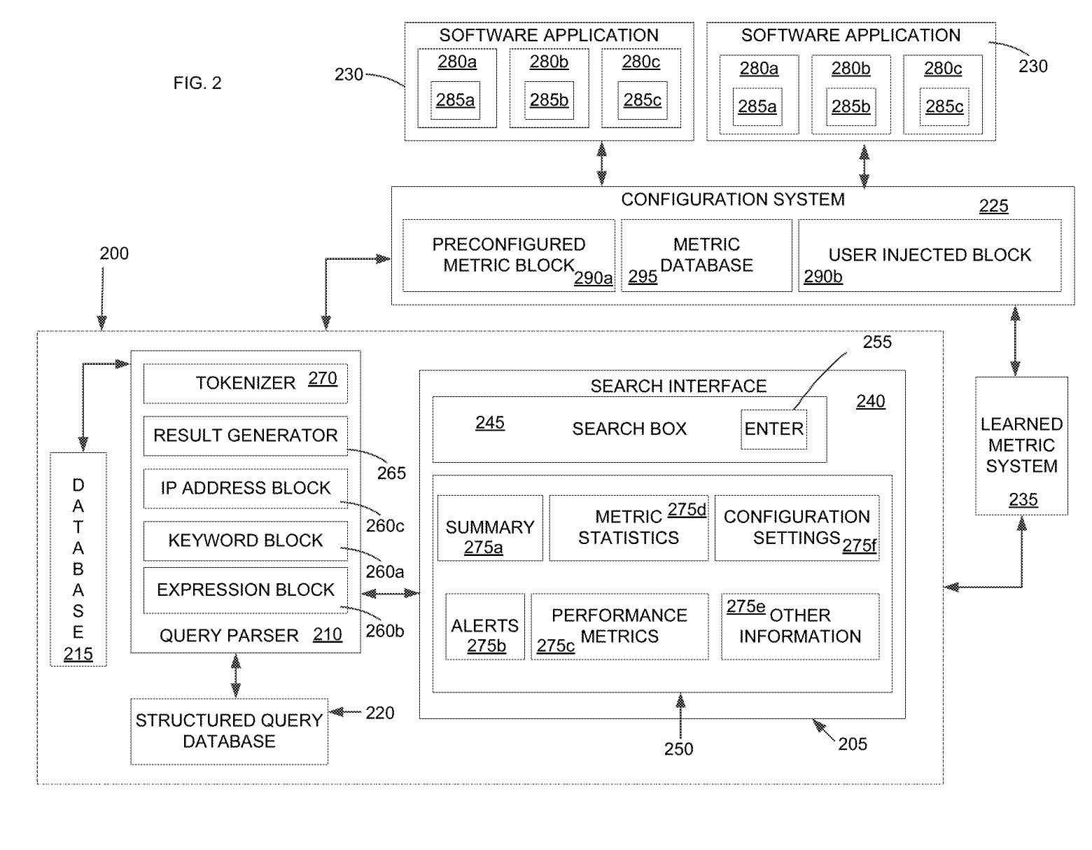

In some embodiments and as described below, the search computing system 170 may be used for troubleshooting purposes as well. For example, the search computing system 170 may be used by a user to run search queries to identify various undesirable conditions within the virtual computing system 100. Further and, as discussed below, the search computing system 170 is associated with a learned metric system (See FIG. 2) and a configuration system (See FIG. 2) to effectively and efficiently detect those undesirable conditions.

Referring still to FIG. 1, each of the user VMs 120 also includes one or more software applications 175 that are designated to perform one or more functions, tasks, or activities. The software applications 175 may be user applications such as word processing applications, multimedia applications, database applications, photo editing applications, web based applications, etc. The software applications 175 may also be system applications that are configured to run, boot, or otherwise manage the operation of the underlying instance of the user VMs 120 or the virtual computing system 100 in general. In some embodiments, the software applications 175 may include a combination of user applications and system applications. Further, the software applications 175 may be configured in a variety of ways. For example, the software applications 175 may be a stand-alone application or be part of an application suite or enterprise software. Generally speaking, the software applications 175 are intended to include any type of software applications that are suitable for use within a virtual environment, such as the virtual computing system 100.

It is to be understood that although a single instance of the software applications 175 is shown in FIG. 1 on each of the user VMs 120, in other embodiments, no software applications or multiple software applications may be provided on one or more of the user VMs. Furthermore, the software applications 175 may be configured to interface with the search computing system 170, such that by using the search computing system, the user may run search queries to obtain statistics related to the software applications 175, as discussed below.

Turning to FIG. 2, a search computing system 200 is shown, in accordance with some embodiments of the present disclosure. The search computing system 200 includes a search interface 205 that is configured to receive search queries from the user and provide search results back to the user. The search computing system 200 is a contextual search system that identifies the context of a search query and particularly, identifies the intent of the user in running the search query. The search computing system 200 may identify the intent of the user by analyzing the search query, as detailed below, to determine whether the user is in a troubleshooting mode, exploration mode, a management mode, or another type of work flow mode. The search computing system 200 may return results back based upon the identified intent of the user.

Specifically, upon receiving a search query, the search interface 205 communicates with a query parser 210. The query parser 210 parses the search query, converts the parsed search query into a structured query, retrieves, compiles, and returns the search results back to the search interface 205. To facilitate parsing of the search query, converting into a structured query, and for retrieving the search results, the query parser 210 communicates with database 215 and structured query database 220. Each of the search interface 205, the query parser 210, the database 215, and the structured query database 220 is described in greater detail below. The search computing system 200 is communicably coupled with a configuration system 225. The configuration system 225 is used to configure metrics for software applications 230, as described below. By configuring metrics for the software applications 230, certain statistics or data pertaining to those software applications may be collected. Statistics or data collected by the configured metrics may be searched using a search query in the search interface 205. The search computing system 200 is also communicably coupled with a learned metric system 235, which may be used to learn the metrics and create correlations related to the software applications 230 based upon the search queries that are being run by the user. In some embodiments, the learned metric system 230 may be part of the search computing system 200.

The search interface 205 includes a user interface 240 having a search box 245 for receiving search queries from the user and a search display box 250 for displaying the search results retrieved in response to the search queries entered into the search box. Thus, the user interface 240 is configured to receive information from and provide information back to the user. The user interface 240 may be any suitable user interface. For example, the user interface 240 may be an interface for receiving user input and/or machine instructions for entry into the search box 245. The user interface 240 may use various input technologies including, but not limited to, a keyboard, a stylus and/or touch screen, a mouse, a track ball, a keypad, a microphone, voice recognition, motion recognition, disk drives, remote controllers, input ports, one or more buttons, dials, joysticks, etc. to allow an external source, such as the user, to enter information into the search box 245.

The user interface 240 may also be configured to provide an interface for presenting information from the search computing system 200 to external systems, users, memory, etc. For example, the user interface 240 may display the search results within the search display box 250. Alternatively or additionally, the user interface 240 may include an interface for a printer, speaker, alarm/indicator lights, etc. to provide or augment the search results. The user interface 240 can be provided on a color display, a cathode-ray tube (CRT), a liquid crystal display (LCD), a plasma display, an organic light-emitting diode (OLED) display, etc. Further, only certain features of the user interface 240 are shown herein. Nevertheless, in other embodiments, other features that are commonly provided on user interfaces and particularly, on user interfaces used in a virtualization environment (e.g., the virtual computing system 100) may be provided. For example, in some embodiments, the user interface 240 may include navigational menus, adjustment options, adjustment settings, adjustment display settings, etc. The user interface 240 may also be configured to send information to and receive information from the query parser 210 and any additional components within the virtual computing system 100 that are deemed desirable to communicate with the search interface 205.

Thus, the user inputs a search query into the search box 245 and interacts with (e.g., click, press-and-hold, roll or hover over, etc.) a search button 255 to send the search query for further processing and retrieval of search results. The search interface 205 and particularly, the search box 245, may be configured to receive and recognize a variety of configurations of the search query. For example, in some embodiments, the user may input the search query in the form of keywords. Keywords are pre-defined terms or phrases that are understood by the search computing system 200. A list of all keywords understood by the search computing system 200 may be stored within (e.g., the database 215) or accessible by the search computing system. The list of keywords may also be made available to the user.

Each keyword may be classified into one or more of four categories: entity type, properties, identifiers, and actions. “Entity type” keywords may include the different entities, such as, clusters, nodes, virtual machines, virtual disks, software applications, and other hardware, software, storage, virtual clouds, and data center components that make up the virtual computing system 100. “Properties” keywords include various attributes, such as type of operating system, number of processing units, number of storage units, etc. of each “entity type.” “Properties” keywords may also include various metrics associated with the “entity type,” as well as values of a given attribute, such as the value of an IP address, values of various statistics and metrics, such as processing unit utilization, disk space, etc. for each “entity type.” The “identifiers” keywords may include any identification information that may be used to uniquely identify an “entity type.” For example, the “identifiers” keywords may include entity name (e.g., host name, cluster name, etc.), entity version, or any other identifying information that may be used to uniquely identify and distinguish one “entity type” from another “entity type” within a cluster. The “actions” keywords may include any actions that a particular “entity type” may be authorized to perform. For example, “actions” keywords may include create, modify, delete, add, etc. that an “entity type” may perform.

In addition to simple keywords, in some embodiments, the user may enter the search query in the form of an expression. Expressions may include phrases or keywords that are separated by an operator. The operator may be a symbol (e.g., =, >, <, etc.) or a subjective keyword (e.g., slow, high, low, top, greater than, less than, equal to, etc.). In some embodiments, the operator may also include advanced filter values (e.g., contains, does not contain, etc.). A valid expression includes a left hand side term and a right hand side term separated by the operator. In some embodiments, the left hand side term may be a keyword or a commonly used, “human friendly,” word. The right hand side term may be a value of the left hand side term. For example, an expression could be “version=5.0.” In this example, the left hand side term, “version,” may be a recognized keyword (or a commonly used term that may be translated into a recognized keyword by the search computing system 200) and the right hand side term, “5.0,” is a value of the left hand side term, “version.” Similar to the keywords, a list of all recognized operators may be stored within or be accessible by the search computing system 200.

In some other embodiments, the user may enter an Internet Protocol (IP) address as the search query. In yet other embodiments, the user may simply use “human friendly” words to construct the search query, which may then be translated by the query parser 210 into recognized keywords. Thus, the user may enter the search query in the form of keywords, expressions, IP addresses, “human-friendly” terms, or a combination thereof. The search interface 205 may also provide other features in the search box 245. For example, in some embodiments, the search box 245 may have an auto-complete feature, such that as the user is inputting (e.g., typing) the search query, the search interface suggests options to complete the query. The search box 245 may also suggest synonyms, alternate terms, and/or keywords that the user may use as part of the search query. Additional features of the search query are described in the U.S. application Ser. No. 15/143,060 mentioned above.

The search query entered into the search box 245 is sent to the query parser 210. The query parser 210 includes a keyword block 260a, an expression block 260b, an IP address block 260c, and a result generator 265. The query parser 210 receives the search query from the search interface 205 and converts that query into a structured query using a tokenizer 270. For example, the tokenizer 270 of the query parser 210 may break or tokenize the search query and particularly, the characters of the search query, into a plurality of tokens. For each token, the tokenizer 270 may parse that token into recognized keywords, expressions, and IP addresses. The tokenizer 270 may communicate with the keyword block 260a, the expression block 260b, and the IP address block 260c to parse the search query. The tokenizer 270 may also convert any “human-friendly” terms in the search query into recognized keywords. After parsing each token, the tokenizer 270 may also convert all of the tokens of the search query into one structured query that is usable by the search computing system 200.

Although not shown, in some embodiments, the tokenizer 270 may also include or be in communication with additional components such as a ranking block to rank the keywords, a relationship block to identify relationships between the keywords, a matching block to match keywords and assign scores, etc. to parse the search query and covert the search query into a structured query. Additional details of converting the search query into a structured query are provided in the above mentioned U.S. application Ser. No. 15/143,060, again, the entirety of which is incorporated by reference herein.

The keyword block 260a may include a list of all keywords recognized by the search computing system 200. Similarly, the expression block 260b may include a list of all recognized expressions, while the IP address block 260c may include a list of all recognized IP addresses. Although shown as separate components, in other embodiments, one or more of the keyword block 260a, the expression block 260b, and the IP address block 260c may be part of the database 215 or combined with one another, or another database within the search computing system 200. In some embodiments, the database 215 itself may be the same as, or a part of, the storage pool 140. In other embodiments, the database 215 may be separate from the storage pool 140 and may be connected to the storage pool 140 in operational association. Also, in some embodiments, the keyword block 260a and/or the expression block 260b may include a correlation of “human-friendly” words into recognized keywords.

The structured queries may be stored within the structured query database 220. Although shown as a separate database, in some embodiments, the structured query database 220 may be part of the database 215, the keyword block 260a, the expression block 260b, the IP address block 260c, and/or another database within the search computing system 200. The structured queries may also be provided to the result generator 265. The result generator 265 may be configured to access the database 215 (as well as other databases accessible to the search computing system 200) to gather results corresponding to the structured queries. The result generator 265 may aggregate and sort the gathered results and display those results within the search display box 250.

The search display box 250 may be divided into various boxes, such as a summary box 275a, an alerts box 275b, a performance metrics box 275c, a metrics statistics box 275d, and other information box 275e. The summary box 275a may display an overall summary of the search results, the alerts box 275b may display any alerts that may have been gathered as part of the search results, the performance metrics box 275c may display results pertaining to various performance metrics, the metric statistics box 275d may display data pertaining to configured metrics of the software applications 230, and the other information box 275e may list any other pertinent data that may have been uncovered by the result generator 265. The result generator 265 may sort the search results to be displayed within these various boxes of the search display box 250. Further, the results displayed within each of the summary box 275a, the alerts box 275b, the performance metrics box 275c, the metrics statistics box 275d, and the other information box 275e may or may not be interactive. If interactive, the user may interact with (e.g., click) a particular item within those boxes to view/access additional information related to that item. Some of the boxes may be empty if there are no results to display.

Although the summary box 275a, the alerts box 275b, the performance metrics box 275c, metrics statistics box 275d, and the other information box 275e are shown herein, in other embodiments, additional, fewer, or different boxes may be displayed. Further, in some embodiments, the number and types of boxes, as well as the shape, size, arrangement, and other configuration of the boxes that are displayed within the search display box 250 may vary in other embodiments. Additionally, the search display box 250 may include a configuration settings box 275f to view or change the settings for how the search results are displayed within the display box, and adjust various settings pertaining to the search interface 205. In some embodiments, the configuration settings box 275f may be provided outside of the search display box 250.

Referring still to FIG. 2, the configuration system 225 is used to configure metrics related to the software applications 230. The software applications 230 are analogous to the software applications 175, discussed in FIG. 1 above. It is to be understood that although only two of the software applications 230 are shown in FIG. 2, in other embodiments, greater than or fewer than two software applications, with each of the application in communication with the configuration system 225 may be used. Further, although the configuration system 225 and the software applications 230 have been shown as being separate from, but in operational association with, the search computing system 200, in other embodiments, either or both of the configuration interface and the software applications may be provided as part of the search computing system.

Further, each of the software applications 230 may be preconfigured (e.g., at the time of creation or installation) with a plurality of metrics. For example and as shown, each of the software applications 230 may include metrics 280a, 280b, and 280c. Although three of the metrics 280a, 280b, and 280c are shown in each of the software applications 230, in other embodiments, fewer than or greater than three metrics may be used in each software application. Further, each of the software applications 230 may include a different number of metrics. The metrics 280a, 280b, and/or 280c may be related to performance measures experienced by end users of the software applications, and/or related to measuring the computational resources used by the software applications. For example, the metrics 280a, 280b, and/or 280c may be related to number of transactions per second processed by the software applications 175, response time of the software applications, CPU utilization, latency, memory parameters, buffer sizes, etc. Additionally, the metrics 280a, 280b, and 280c of each of the software applications 230 may be different based upon the functionality of that software application. For example, a software application that is designed for word processing may have different metrics than a software application that is designed for image processing. Generally speaking, the metrics 280a, 280b, and 280c depend upon the type and functionality of the software applications 230 with which the metrics are associated.

Each of the metrics 280a, 280b, and 280c is used to collect statistics or data from the respective one of the software applications 230. The data that is collected depends upon the type of information that the particular one of the metrics 280a, 280b, and 280c is designed to collect. For example, a metric designed for CPU utilization may collect data pertaining to resource usage of the underlying software application. Likewise, a metric designed for latency may collect data pertaining to latency of the underlying software application. Furthermore, the metrics 280a, 280b, and 280c are configured to collect the data discussed above when the underlying instance of the software applications 230 is running, whether actively or passively in the background. The data collected by the metrics 280a, 280b, and 280c may provide valuable insights into the operation of the software applications 230, as discussed above. The user may run a search query using the search interface 205 to review the collected data to identify any currently occurring or impending problems with the software applications 230 in real-time.

Before the data collected by the metrics 280a, 280b, and 280c may be searched using a search query in the search interface 205, those metrics are configured. The metrics 280a, 280b, and 280c may be configured by defining various filters (e.g., limiting parameters or attributes) and creating statistics counters 285a, 285b, and 285c, respectively, for the configured metrics using the configuration system 225. The configured metrics may be stored within the configuration system 225, a database associated with the software applications 230, or any other database associated with the search computing system 200. By configuring the metrics 280a, 280b, and 280c and searching for those metrics using the search interface 205, the user may obtain a real-time view of the operation of the software applications 230 and identify any issues related to those software applications that may need attention.

Although each of the metrics 280a, 280b, and 280c has been described as being configured and having a corresponding instance of the statistics counters 285a, 285b, and 285c, in some embodiments, not all of the metrics need to be configured. For example, only those ones of the metrics 280a, 280b, and 280c for which the user desires to review the collected data using the search interface 205 may be configured. Additionally, in some embodiments, one or more of the metrics 280a, 280b, and 280c may have multiple configurations, with each configuration varying from the other configurations in some aspect (e.g., by using different filters or different values of the same filters). Moreover, each of the metrics 280a, 280b, and 280c may have a keyword associated therewith that is recognized by the search computing system 200. Those keywords may be stored within the keyword block 260a. Furthermore, although the statistics counters 285a, 285b, and 285c have been shown as being part of the software applications 230, in other embodiments, the statistics counters may instead or additionally be stored within the configuration system 225 or within any other database associated with the search computing system 200.

Furthermore, the metrics 280a, 280b, and 280c may be classified into two categories: preconfigured metrics and user injected metrics. Preconfigured metrics are those metrics that are already configured within the software applications 230 at the time of creation or installation of the software application. In other words, the preconfigured statistics counters are not configured by the users, and the users may not have the ability to vary the configuration (e.g., change filters) of the preconfigured metrics. The preconfigured metrics may be stored within a preconfigured metric block 290a of the configuration system 225. In contrast to the preconfigured metrics, the user injected metrics are configured by the user. The user may configure one or more of the metrics 280a, 280b, and 280c by assigning one or more filters, as discussed below. The user may also create the statistics counters 285a, 285b, 285c for the configured metrics. Additionally, the user may have the ability to delete or modify the user injected metrics. The user injected metrics may be created using a user injected block 290b of the configuration system 225.

The configured metrics and their corresponding statistics counters may be stored within a metric database 295 of the configuration system 225. Although the metric database 295 has been shown separate from the preconfigured metric block 290a and the user injected block 290b, in some embodiments, one or more of those components may be integrated together.

Referring still to FIG. 2, the learned metric system 235 is used to learn the metrics 280a, 280b, 280c and their various attributes (e.g., parameters) from the search queries that are run by the user. The metrics that are learned by the learned metric system 235 may or may not have been configured by the user. Thus, the learned metrics may include preconfigured metrics, the user injected metrics, or any other metric that is associated with the software applications 230. The learned metric system 235 may learn metrics (or attributes of those metrics) based upon the frequency of a search query or based upon a pattern of search queries run by the user.

Thus, in some embodiments, the learned metric system 235 may be configured to look for certain patterns of search queries. For example, if the learned metric system 235 determines that the user is running a search query for a particular one of the software applications 230 (e.g., “Application A”), followed by a search query for “CPU utilization greater than 75%,” the learned metric system 235 may infer that the user is interested in searching for “CPU utilization greater than 75%” in the “Application A.” The learned metric system 235 may create a correlation between the “Application A” and the “CPU utilization greater than 75%,” and store the correlation within the learned metric system. By creating such correlations, in the future, when the user searches for “Application A,” the learned metric system 235 may identify that a correlation exists for “Application A” and the search interface 205 may propose “CPU utilization greater than 75%” in an auto-complete feature while the user is typing the search query, or alternatively, when displaying the results within the search display box 250, the search interface may obtain results relating to “CPU utilization greater than 75%” for “Application A.” Likewise, if the user searches for “CPU utilization greater than 75%,” the learned metric system 235 may identify that a correlation exists with “Application A” and obtain results CPU utilization results related to “Application A.” Thus, by identifying and creating correlations using the learned metric system 235, the search computing system 200 attempts to determine the intent of the user in running a particular search, and provides appropriate search results based upon the identified intent, thereby saving the user's time and providing results that are useful to the user.

Although the correlation described above is based upon two consecutive search queries, in some embodiments, the learned metric system 235 may be configured to identify and create correlations from more than two consecutive search queries, or possibly from non-consecutive search queries as well. For example, if the user has searched for “Application A,” which is a word processing software application (e.g., the software applications 230) followed by “Application B,” which is an image processing software application, and further followed by “Metric A,” which relates to “Application A” but not “Application B,” then the learned metric system 235 may identify a correlation between “Application A” and “Metric A” even though a search for “Application B” was run in between.

The learned metric system 235 may be configured to identify correlations in search queries based upon rules programmed within the learned metric system. The rules may specify what correlations are deemed acceptable. For example, in some embodiments, the learned metric system 235 may include information pertaining to some or all of the software applications 230 associated with the search computing system 200, as well as the metrics 280a, 280b, and 280c that are associated with one of the software applications. The learned metric system 235 may also include commonly used thresholds, values, attributes, units, and/or other information of the data that those metrics are configured to collect from the software applications. In other embodiments, additional, fewer, or different information may be used to identify correlations. In some embodiments, the learned metric system 235 may collaborate with the query parser 210 to obtain structured queries and identify keywords indicative of correlations in accordance with the programmed rules.

In addition to or instead of identifying patterns of search queries and creating correlations from those patterns, in some embodiments, the learned metric system 235 may look for the frequency of a particular search query. For example, if the user has searched for a particular metric (e.g., the metrics 280a, 280b, 280c), an attribute of the particular metric, or a combination thereof greater than a predetermined number of times within a predetermined number of period, the learned metric system 235 may infer that the user is interested in monitoring the particular metric identified from the search query, and learn that metric. By learning the metrics or by creating correlations, the search computing system 200 may return pertinent results even if the user has not created a statistics counter (e.g., the statistics counters 285a, 285b, 285c) for a particular metric (e.g., the metrics 280a, 280b, 280c).

The search computing system 200 is configured to communicate with the search computing system 200 to both learn the metrics, create correlations, as well as to return results related to the learned metrics and correlations. Although shown separate from the search computing system 200 and the configuration system 225, in some embodiments, the learned metric system 235 may be part of the configuration system or the search computing system. The learned metric system 235 may work in collaboration with at least the query parser 210 for converting the search queries into structured queries, and for identifying keywords, expressions, and IP addresses within the search queries. In some embodiments, the learned correlations and metrics may be stored within the database 215, the metric database 295, or another database associated with the search computing system 200.

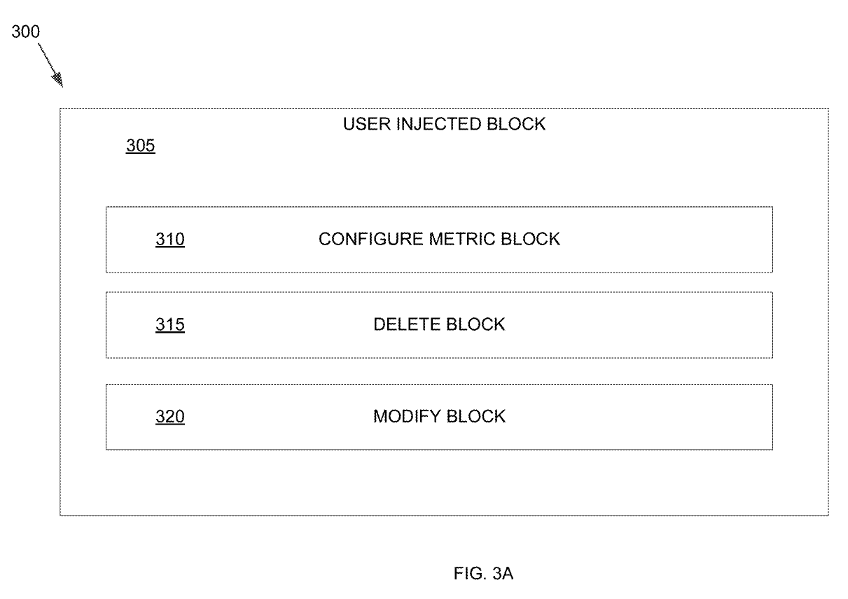

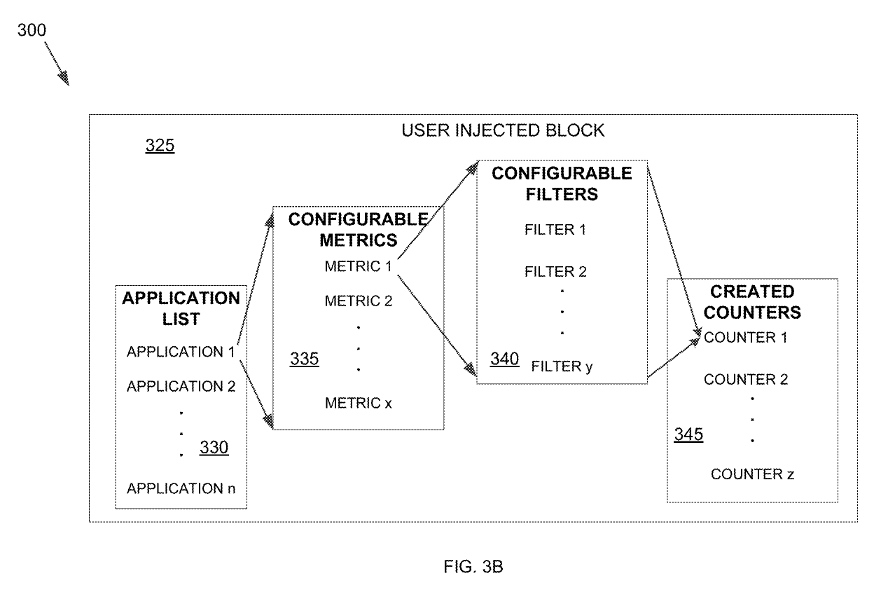

Referring now to FIGS. 3A and 3B, block diagrams showing an example of a user injected block 300 is shown, in accordance with some embodiments of the present disclosure. As discussed above, the user injected block 300 may be used by the user to configure one or more of the metrics 280a, 280b, and 280c. The user injected block 300 may also be used to create new statistics counters as part of the configuration process, as well as to edit and delete existing statistics counters. Referring specifically to FIG. 3A, the user injected block 300 may include a configuration interface 305. The configuration interface 305 may present various options to the user for managing existing statistics counters or for creating new statistics counters. For example, the configuration interface 305 may include a configure metric block 310 for enabling the user to configure a metric and to create a new statistics counter, a delete block 315 for deleting existing statistics counters, and a modify block 320 for editing (e.g., changing the filters) the existing statistics counters.

It is to be understood that the configuration interface 305 is only an example. The size, shape, and design of the configuration interface 305 may vary from one embodiment to another. Likewise, the arrangement and other configuration of the configure metric block 310, the delete block 315, the modify block 320, as well as any other feature provided within the configuration interface 305 may vary from one embodiment to another. Furthermore, in some embodiments, one or more of the configure metric block 310, the delete block 315, and the modify block 320 may be merged together into a single feature. Additionally, only some features of the configuration interface 305 are shown herein. Nevertheless, the configuration interface 305 may include additional features that may be desired. Generally speaking, the configuration interface 305 may have similar features as the user interface 240.

To configure a metric (e.g., the metrics 280a, 280b, and 280c), the user interacts with (e.g., click on) the configure metric block 310. Upon interacting with the configure metric block 310 of the configuration interface 305, the user may be taken to configuration interface 325 of FIG. 3B. Within the configuration interface 325, the user is presented with an application list 330. The application list 330 may include a list of all software applications (e.g., the software applications 230) that are associated with the search computing system 200 and that have metrics that may be configured by the user. The user may interact with (e.g., click on) the software application within the application list 330 for which the user desires to configure metrics for. For example, as shown, if the user desires to configure metrics for “Application 1” in the application list 330, the user may interact with (e.g., click on) “Application 1.”

Interacting with “Application 1” opens another dialog box with configurable metrics list 335. The configurable metrics list 335 may include a list of metrics that are available to the user to configure. The user may select (e.g., by clicking on) the metric from the configurable metrics list 335 that the user desires to configure. For example, if the user desires to configure “Metric 1,” the user may interact with (e.g., click on) “Metric 1” to open another dialog box related to configurable filters 340. The configurable filters 340 may include a list of all filters that are available for the selected “Metric 1” that the user may apply to the metric. For example, the configurable filters 340 may include an upper threshold filter, a lower threshold filter, or any other configurable attribute suitable for being applied as a filter for “Metric 1.”

The user may assign specific filter values to one or more selected filters within the configurable filters 340. Specifically, the user may interact with the specific filter within the configurable filters 340 that the user desires to apply to “Metric 1.” For example, if a filter within the configurable filters 340 is an upper threshold filter, the user may interact with (e.g., click on) the upper threshold filter to set the desired value for the upper threshold. In some embodiments, the accepted filter values may be presented to the user in the form of a drop down list. In some embodiments, there may be predefined limits within with the filter values may be set by the user. The conditions imposed on a particular filter value may depend upon the type of application (e.g., “Application 1”), type of metric (e.g., “Metric 1”), as well as the type of filter (e.g., “upper threshold”) that the user is configuring. For example, for a CPU utilization metric, the upper threshold may have a filter value in percentage form, while for a latency metric, the upper threshold may have a filter value in seconds (or another unit of time). Furthermore, the values of the filters may vary depending upon the application (e.g., “Application 1”).

It is to be understood that the configurable filters 340 may include a variety of filter options that may be suitable for the selected metric (e.g., “Metric 1”). However, the user need not assign a filter value to each filter option provided within the configurable filters 340. In some embodiments, the user may assign filter values only to the desired filters options within the configurable filters 340. For example, in some embodiments, the user may only assign an “upper threshold” filter value, and not a “lower threshold” filter value, etc.

After assigning all the desired filter values within the configurable filters 340, the user may create a statistics counter for the configured metric, “Metric 1.” For example, in some embodiments, the user may assign the created statistics counter a counter name. In other embodiments, the user injected block 300 may assign the created statistics counter a name. In some embodiments, the name of the created statistics counter may include the name of the metric (e.g., “Metric 1”) for which the statistics counter has been created. The created statistics counter may be stored within a statistics counters list 345. Although the statistics counters list 345 has been shown as being part of the user injected block 300, in some embodiments, the statistics counters list may be part of the metric database 295 and/or the software applications 230.

It is to be understood that the configuration interface 325 is only an example. In other embodiments, the configuration interface 325 and particularly, the various dialog boxes (e.g., the application list 330, the configurable metrics list 335, configurable filters 340, and the statistics counters list 345) may vary from one embodiment to another. Additionally, the dialog boxes (e.g., the application list 330, the configurable metrics list 335, configurable filters 340, and the statistics counters list 345) have been shown together within the configuration interface 325 for ease of explanation. In other embodiments, the configuration of those dialog boxes, how they are displayed, arranged, or otherwise designed may vary. Further, additional options may be provided within one or more of those dialog boxes in other embodiments. For example, in some embodiments, one or more of the application list 330, the configurable metrics list 335, configurable filters 340, and the statistics counters list 345 may include only those options that are configurable by the user. In other embodiments, one or more of the application list 330, the configurable metrics list 335, configurable filters 340, and the statistics counters list 345 may include those options as well that are not configurable by the user. Such options may be provided such that while they are visible to the user, the user may not be able to interact with (e.g., click on) those options or configure those options in any way. For example, such options may be “grayed-out.”

Returning to FIG. 3A, in addition to configuring the metrics (e.g., the metrics 280a, 280b, 280c), the user may delete or modify the existing statistics counters using the configuration interface 305. To delete one or more existing statistics counters, the user may interact with the delete block 315. The user may be presented with the statistics counters list 345 (or a similar list with all the created statistics counters), and the user may select the statistics counter to be deleted from that list. Likewise, to modify an existing statistics counter, the user may interact with the modify block 320. Within the modify block 320, the user may be presented with all of the created statistics counters, as well as their configured (and non-configured) filter values. The user may change the filter values and save the changes to modify the configuration of a metric.

Thus, the user injected block 300 may be used for configuring one or more of the metrics 280a, 280b, 280c and creating, deleting, or modifying statistics counters (e.g., the statistics counters 285a, 285b, 285c) for those metrics.

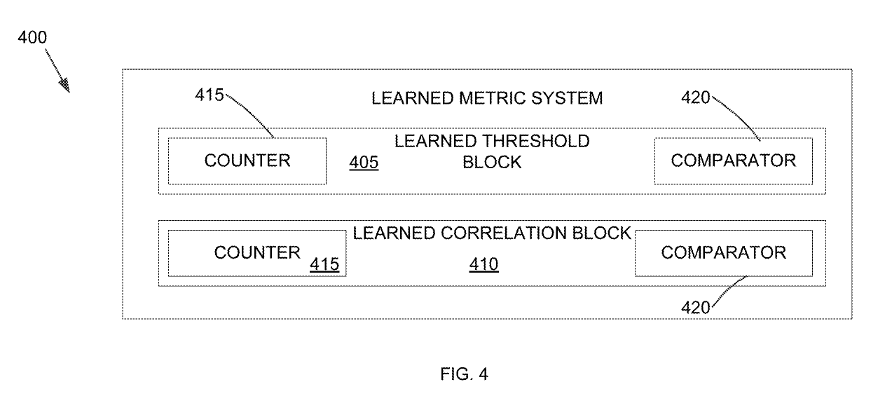

Turning now to FIG. 4, an example block diagram of a learned metric system 400 is shown, in accordance with some embodiments of the present disclosure. As indicated above, the learned metric system 400 is used for learning metrics (and/or their associated attributes) and/or creating correlations that may be used to assist the user in conducting searches using the search interface 205. The learned metric system 400 includes a learned threshold block 405 and a learned correlation block 410. The learned threshold block 405 is used to learn frequently searched metrics and/or their associated thresholds. The learned correlation block 410 is used to identify and create correlations based upon patterns of search queries that are run by the user.

Each of the learned threshold block 405 and the learned correlation block 410 includes a counter block 415 and a comparator block 420. The counter block 415 of the learned threshold block 405 is used to keep track of a number of times a particular search query for a particular metric has been run by the user. When the count value within the counter block 415 exceeds a predetermined threshold, as determined by a comparison of the count value with the predetermined threshold by the comparator block 420, the learned threshold block 405 identifies that search query for learning. To learn a particular search query, the learned thresholds block 405 may store the search query (e.g., the structured query corresponding to that search query) within a database.

Similarly, the counter block 415 of the learned correlation block 410 may be used to identify a number of times that a particular pattern of the search queries has occurred. When a count value of the pattern within the counter block 415 exceeds a predetermined threshold as determined by the comparator block 420, the learned correlation block 410 may create a correlation based on that pattern. The created correlation may be in the format, for example, <name of software application><metric><threshold>. For example, in some embodiments, a correlation may look like <Application A CPU utilization greater than 75%>. Other formats may be used for creating correlations as well in other embodiments.

Thus, the learned metric system 400 may learn the search queries that the user is running to enable the search computing system 200 to provide faster and more accurate results. The learning of the search queries is particularly useful when the user has not created a statistic counter for a particular metric.

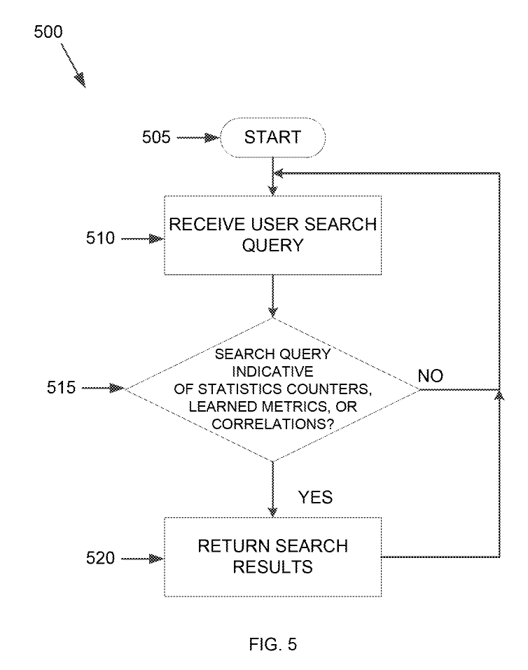

Referring now to FIG. 5 in conjunction with FIG. 2, a flowchart outlining a process 500 for searching for data related to metrics of the software applications 230 using the search interface 205 is shown, in accordance with some embodiments of the present disclosure. The process 500 may include additional, fewer, or different operations, depending on the particular embodiment. After starting at an operation 505, the user enters a search query into the search box 245 of the search interface 205. The format of the search query may take various forms. For example, the search query may include the name of a software application (e.g., the software applications 230), the name of a particular metric associated with the software application, and/or a value of the metric. One or more operators (e.g., >, <, =) and/or performance keywords (e.g., less than, greater than, etc.) may be used as well within the search query. Further, as noted above, the search query may be in the form of keywords, expressions, “human friendly” words, IP addresses, or a combination thereof.

To input the search query, the user interacts with (e.g., clicks on) the search button 255. The input search query is sent to the query parser 210, which tokenizes the search query, and categorizes each token into keywords, expressions, and IP addresses. Based upon the categorization, the query parser 210 converts the search query into a structured query, which may be stored within the structured query database 220.

At operation 515, the query parser 210 determines from the structured query of the operation 510 whether the search query includes keywords or expressions that may be indicative of an existing statistics counter (e.g., the statistics counters 285a, 285b, 285c), a metric related to one or more of the software applications 230 (e.g., the metrics 280a, 280b, 280c), and/or a value of that metric. If the query parser 210 determines that the search query is indicative of an existing statistics counter (e.g., the statistics counters 285a, 285b, 285c), then the query parser and particularly, the result generator 265 of the query parser may access the metric database 295 to retrieve the data published to that statistics counter by the associated metric at operation 520. In some embodiments, the query parser 210 may identify the statistics counters in the search query based upon keywords in the keyword block 260a that may have been associated with the created statistics counters, by accessing the user injected block 290b and/or the metric database 295, both of which may have a list of all existing statistics counters.

If the query parser 210 determines that the search query is not indicative of an existing statistics counter, but rather includes the name (or keyword) of a metric or a value of a metric, the query parser may determine whether the metric and/or the value of the metric is a learned metric and if a correlation exists for that metric. The query parser 210 may access the learned metric system 235 to make such a determination. If the query parser 210 determines that the search query is a learned metric or that a correlation exists for the metric in the search query, the result generator 265 may access one or more of the preconfigured metric block 290a, the metric database 295, the database 215, and/or another database associated with the search computing system 200 to gather the results associated with the learned metric or the identified correlation.

It is to be understood that the identification by the query parser 210 of whether the search query relates to a statistics counter, a learned metric, and/or correlation may occur simultaneously even though it has been described above as a sequential procedure. The result generator 265 may return the gathered results, at the operation 520, on the search display box 250 and particularly within one or more of the summary box 275a, the alerts box 275b, the performance metrics box 275c, the metrics statistics box 275d, and/or the other information box 275e. The process 500 then loops back to the operation 510 to wait for the next search query.

On the other hand, if at the operation 515, the query parser 210 determines from the structured query that the search query is neither an existing statistics counter, nor a learned metric or a correlation, the process 500 loops back to the operation 510 to wait for the next search query. In some embodiments, if the query parser 210 determines that the that the search query is neither an existing statistics counter, nor a learned metric or a correlation, but still relates to a metric and/or a value of the metric, the result generator may still gather the results that may be associated with the metric and/or the value of the metric. However, such results need not be limited to the software applications 230. Rather, the result generator 265 may gather results from all components (including the software applications 230) that may be connected to the search computing system 200. The gathered results may be displayed on the search display box 250. However, these results may include data that the user may not be interested in and the user may be required to sift through the data to retrieve the desirable information. Therefore, establishing statistics counters, learning metrics, and/or creating correlations is a useful and efficient mechanism for obtaining the relevant results pertaining to the desired metrics of the software applications 230 quickly.

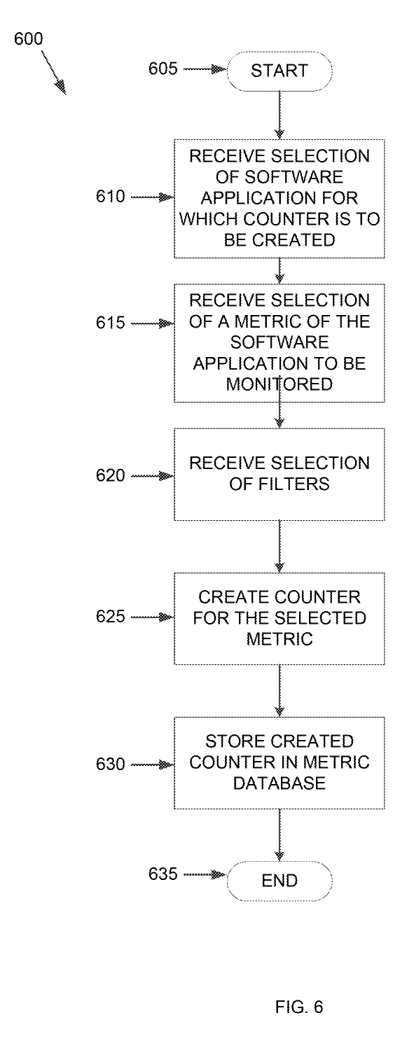

Turning now to FIG. 6 in conjunction with FIG. 3B, a flowchart outlining a process 600 for configuring a metric and creating a statistics counter is shown, in accordance with some embodiments of the present disclosure. The process 600 may include additional, fewer, or different operations, depending on the particular embodiment. After starting at operation 605, the user accesses the user injected block 300. Within the configuration interface 325 of the user injected block 300, the user selects a software application (e.g., from the application list 330) to create a statistics counter for. The selection is sent to the user injected block 300 at operation 610, which presents the configurable metrics list 335 upon receiving the selection of the software application. The user then selects a metric from the configurable metrics list 335. The selection is sent back to the user injected block 300 at operation 615, which in turn presents the configurable filters 340 to the user.

Although the process 600 is described as the user selecting one metric from the configurable metrics list 335, in some embodiments, the user may be able to select multiple metrics and configure all of the selected metrics simultaneously. In other embodiments, the user may be able to configure multiple metrics, but one at a time. Thus, the statistics counter that is created may be for a single metric or for multiple metrics of the software application selected by the user above.

From the configurable filters 340, the user may set various filters corresponding to the metric(s) selected above. For example, the user may provide an upper threshold value, a lower threshold value, etc. The user injected block 300 receives the user's filter selections at operation 620 and creates a statistics counter at operation 625. Specifically, in some embodiments, the user may assign a user friendly name to the newly created statistics counter. In addition to or instead of the user friendly name, the user injected block 300 may assign a keyword to the newly created statistics counter. The keyword associated with the newly created keyword may be stored within the keyword block 260a. Additionally, the user injected block 300 stores the newly created statistics counter within the metric database 295 at operation 630. In some embodiments, the statistics counter may be stored within another database associated with the search computing system 200.

Furthermore, periodically based upon a predetermined interval or when new data becomes available, or based upon a filter value specified within the statistics counters, the software applications 230 may publish the data corresponding to the metrics for which the statistics counters are created. Such data may be stored within the metric database 295 along with the statistics counters. Thus, when the user searches for a particular statistics counter, the search computing system 200 may access the metric database 295 to obtain real time data pertaining to the underlying metrics associated with a particular software application. The process 600 ends at operation 635.

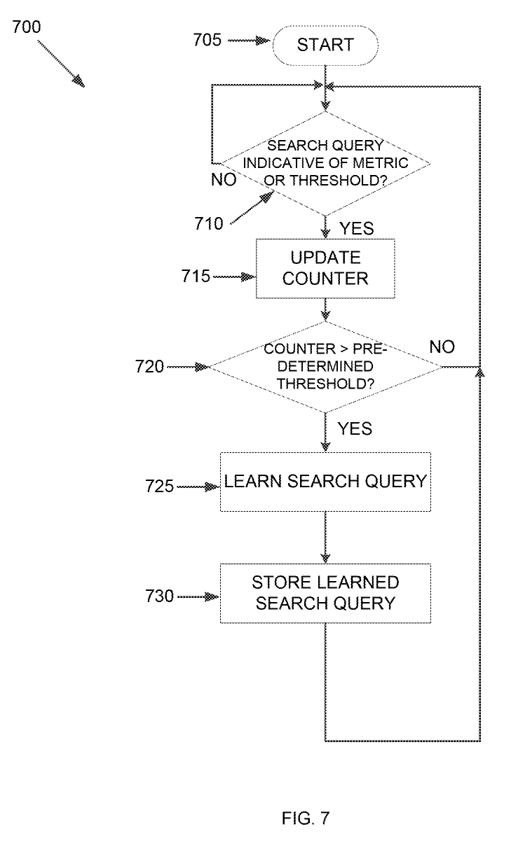

Turning now to FIG. 7, a flowchart outlining a process 700 for learning metrics is shown, in accordance with some embodiments of the present disclosure. The process 700 may include additional, fewer, or different operations, depending on the particular embodiment. After starting at operation 705, the process 700 waits for a user to enter a search query in the search box 245. When the user inputs the search query, at operation 710, the search computing system 200 converts the search query into a structured query, as outlined above. The structured query is provided to the learned metric system 235, which identifies keywords indicative of metrics and/or thresholds associated with one or more of the software applications 230. In some embodiments, the learned metric system 235 may poll the structured query database 220 for new structured queries. In other embodiments, the structured query database 220 and/or the query parser 210 may provide new structured queries to the learned metric system 235.

The learned metric system 235 and particularly, the learned threshold block 405 of the learned metric system, may parse the structured query to identify keywords associated with metrics and/or thresholds of one or more of the software applications 230. If the learned threshold block 405 identifies keywords associated with the metrics and/or thresholds of one or more of the software applications 230, the learned threshold block updates a count value within the counter block 415 at operation 715. At operation 720, the learned threshold block 405 compares the count value with a predetermined threshold by using the comparator block 420. If the count value is greater than the predetermined threshold, then the learned threshold block 405 learns the metric corresponding to the search query at operation 725 and stores the learned metric within the learned threshold block 405. In some embodiments, the learned metrics may be stored within the database 215, the metric database 295, or another database associated with the search computing system 200. The process 700 the returns to the operation 710 to start learning another metric. The process of learning metrics may occur simultaneously with gathering of search results by the result generator 265, as described in FIG. 5 above.

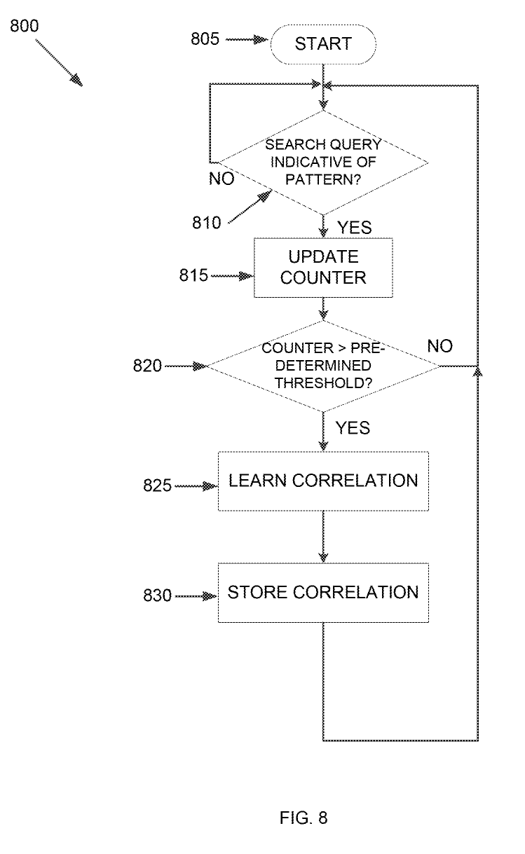

Referring now to FIG. 8, a flowchart outlining a process 800 for learning correlations is shown, in accordance with some embodiments of the present disclosure. The process 800 may include additional, fewer, or different operations, depending on the particular embodiment. After starting at operation 805, the process 800 waits for a user to enter a search query in the search box 245. When the user inputs the search query, at operation 810, the search computing system 200 converts the search query into a structured query, as outlined above. From the structured query, the search computing system 200 and particularly, the learned metric system 235 of the search computing system, identifies patterns of search queries relating to metrics and/or thresholds of one or more of the software applications 230. As discussed above, in some embodiments, the learned metric system 235 may poll the structured query database 220 for new structured queries, while in other embodiments, the structured query database 220 and/or the query parser 210 may provide the new structured queries to the learned metric system.

The learned metric system 235 and particularly, the learned correlation block 410 of the learned metric system, may parse the structured query to identify patterns of search queries related to one or more of the software applications 230. For example, in some embodiments, the learned correlation block 410 may review the search queries received by the learned correlation block within a predetermined period of time preceding the structured query received at the operation 810. In other embodiments, the learned correlation block 410 may review a predetermined number of search queries received prior to the structured query received at the operation 810. Based upon the review of the prior structured queries, the learned correlation block 410 identifies whether a specific pattern is formed. Rule or guidelines for correlating search queries as an acceptable pattern may be stored within the learned correlation block 410.

For example, in some embodiments, a rule may indicate that if the prior structured queries along with the current structured query received at the operation 810 includes the name of one or more of the software applications, one or more metrics or thresholds associated with those software applications, a correlation may be found. If the learned correlation block 410 identifies a correlation, the learned correlation block updates a count value within the counter block 415 at operation 815. At operation 820, the learned correlation block 410 compares the count value with a predetermined threshold by using the comparator block 420. If the count value is greater than the predetermined threshold, then the learned correlation block 410 learns the correlation at operation 825 and stores the learned correlation within the learned correlation block 410. By using the counter block 415 and the comparator block 420, the learned correlation block 410 may identify commonly searched correlations and learn only those correlations that are frequently searched by the user.

In other embodiments, the learned correlation block 410 may be configured such that each time the learned correlation block identifies a correlation, that correlation is learned and saved. In such embodiments, the counter block 415 and the comparator block 420 may not be needed. Further, in some embodiments, the learned correlations may be stored within the database 215, the metric database 295, or another database associated with the search computing system 200. The process 800 the returns to the operation 810 to start learning another search query. The process of identifying and creating correlations may occur simultaneously with learning metrics and gathering search results by the result generator 265. It is also to be understood that a particular one or more of the metrics of the software applications 230 may be configured into one or more statistics counters, learned metrics, and/or be part of a correlation. Further, although the present disclosure has been described in terms of configuring metrics for software applications, in other embodiments, the teachings of the present disclosure may also be used to configure metrics for other components of the virtual computing system. For example, in some embodiments, the teachings of the present disclosure may be applied to a troubleshooting infrastructure to identify problems, issues, or to otherwise gain insight relating to various troubleshooting parameters. As an example, a metric may be configured for CPU Utilization of the controller/service VM 130. The configured metric may then be used to monitor issues with the controller/service VM 130. Similarly, the present disclosure may be applied to other components as well.

Thus, the present disclosure provides a system and method for automatically monitoring one or more metrics of software applications that the user may desire to monitor. To facilitate the monitoring, the user may configure the metrics that the user desires to monitor. Those metrics are configured by defining filters and creating statistics counters. By creating statistics counters, the metrics may publish data to the statistics counters based upon the defined filters. The users may simply search for the statistics counters to obtain the real-time data pertaining to the metrics. Such data may offer a glimpse into any currently occurring or impending problems associated with the software application, and allow the user to pro-actively address those problems. Thus, the present disclosure provides a simple and effective mechanism to monitor the software applications within the virtual computing system in real-time. The present disclosure also provides a system and method to automatically learn metrics, as well as identify and create correlations for the metrics of the software applications based upon the search queries that are run by the user. Thus, the present disclosure aids the user in troubleshooting by timely identifying certain problems.

Although the present disclosure has been described with respect to software applications, in other embodiments, one or more aspects of the present disclosure may be applicable to other components of the virtual computing system 100 that may be suitable for real-time monitoring by the user.

It is also to be understood that in some embodiments, any of the operations described herein may be implemented at least in part as computer-readable instructions stored on a computer-readable memory. Upon execution of the computer-readable instructions by a processor, the computer-readable instructions may cause a node to perform the operations.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method comprising:
receiving, by a search computing system of a virtual computing system, a search query via a search interface;
converting, by the search computing system, the search query into a structured query;
identifying, by the search computing system, at least one of a configured metric, a learned metric, and a correlation from the structured query, wherein the configured metric, the learned metric, and the correlation are based upon a particular metric associated with a component of the virtual computing system, and
wherein the configured metric is obtained by applying one or more filters to the particular metric, the learned metric is based upon a frequency of presence of the particular metric in the search query, and the correlation is based upon a pattern formed by the search query in conjunction with a subset of prior search queries; and
displaying, by the search computing system, data related to the particular metric on the search interface, wherein the data is based upon the configured metric, the learned metric, and the correlation identified within the structured query.

2. The method of claim 1, wherein identifying the configured metric in the structured query comprises identifying keywords in the structured query indicative of a statistics counter associated with the configured metric.

3. The method of claim 1, wherein the component is a software application and configuring the metric comprises:
receiving a selection, by a configuration system of the virtual computing system, of the software application, wherein the configuration system is associated with the search computing system;
receiving a selection, by the configuration system, of the particular metric;
receiving a selection, by the configuration system, of the one or more filters;
receiving, by the configuration system, filter values to be assigned to the one or more filters; and
applying, by the configuration system, the software application, the particular metric, the one or more filters, and the filter values to a statistics counter to obtain the configured metric.

4. The method of claim 1, wherein the data based upon the configured metric satisfies the one or more filters.

5. The method of claim 1, further comprising:
receiving, by a learned metric system of the virtual computing system, the structured query, wherein the learned metric system is operationally associated with the search computing system; and
identifying keywords within the structured query that are indicative of the pattern.

6. The method of claim 5, further comprising:
incrementing, by the learned metric system, a count of a counter for each instance of the pattern identified by the learned metric system;
comparing, by the learned metric system, the count with a pre-determined threshold; and
creating, by the learned metric system, the correlation upon the count exceeding the pre-determined threshold.

7. The method of claim 1, further comprising:
receiving, by a learned metric system of the virtual computing system, the structured query, wherein the learned metric system is operationally associated with the search computing system; and
identifying keywords within the structured query that are indicative of the particular metric or a value of the particular metric.

8. The method of claim 7, further comprising:
incrementing, by the learned metric system, a count of a counter for each instance of the particular metric or the value of the particular metric identified in the structured query;
comparing, by the learned metric system, the count with a pre-determined threshold; and
learning, by the learned metric system, the learned metric upon the count exceeding the pre-determined threshold.

9. The method of claim 1, wherein the learned metric and the correlation are created by a learned metric system of the virtual computing system without user input, wherein the learned metric system is associated with the search computing system.

10. The method of claim 1, further comprising, accessing, by the search computing system, one or more databases associated with the virtual computing system for gathering the data before displaying.

11. A system, comprising:
a configuration system of a virtual computing system, the configuration system comprising:
a metric database configured to store one or more statistics counters created by the configuration system; and
a processing unit configured to:
receive a selection, via a configuration interface, of a software application;
receive a selection, via the configuration interface, of a particular metric associated with the software application;
receive a selection, via the configuration interface, of one or more filter values associated with selected one of the particular metric;
apply the selected one of the particular metric and the one or more filter values to an instance of the one or more statistics counters; and
store the instance of the one or more statistics counters within the metric database.

12. The system of claim 11, wherein the configuration system is provided on a user virtual machine within the virtual computing system.

13. The system of claim 12, wherein the user virtual machine is created on a host machine that is connected to other host machines within the virtual computing system via a network to form one or more clusters.

14. The system of claim 11, further comprising a search computing system of the virtual computing system, wherein the search computing system is configured to access the metric database in response to search queries received by the search computing system via a search interface.

15. The system of claim 14, further comprising a learned metric system configured to learn metrics based upon a frequency of the search queries received by the search computing system.

16. The system of claim 14, further comprising a learned metric system configured to identify correlations based upon a pattern of the search queries received by the search computing system.

17. A method comprising:
configuring, by a configuration system of a virtual computing system, a particular metric associated with a component of the virtual computing system to obtain a configured metric, wherein the configuring comprises applying one or more filter values to the particular metric;
receiving, by a search computing system of the virtual computing system, a search query via a search interface;
identifying, by the search computing system, keywords within the search query indicative of the configured metric;
accessing, by the search computing system, the configuration system for obtaining data corresponding to the configured metric; and
displaying, by the search computing system, the data on the search interface.

18. The method of claim 17, wherein the component is a software application, and the configuring comprises:
receiving, by the configuration system, a selection of the software application via a configuration interface;
receiving, by the configuration system, a selection of the particular metric via the configuration interface;
receiving, by the configuration system, selection of one or more filters associated with the particular metric via the configuration interface;
receiving, by the configuration system, the one or more filter values for the selected ones of the one or more filters;
applying, by the configuration system, the one or more filter values to the selected ones of the one or more filters; and
applying, by the configuration system, the particular metric, the one or more filters, and the one or more filter values to an instance of a statistics counter.

19. The method of claim 18, further comprising receiving, by the configuration system, the data from the software application, wherein the data satisfies the one or more filters and the one or more filter values.

20. The method of claim 18, wherein identifying keywords in the search query comprises identifying presence of the statistics counter in the search query.
